(19) United States
(12) Patent Application Publication
(10) Pub. No.: US 2025/0021948 A1
(43) Pub. Date: Jan. 16, 2025

(54) SYSTEMS AND METHODS FOR TRANSACTION FACILITATION VIA A PLURALITY OF CLEARINGHOUSE DEVICES

(71) Applicant: Wells Fargo Bank, N.A., San Francisco, CA (US)

(72) Inventors: Rameshchandra Bhaskar Ketharaju, Hyderabad (IN); Ashutosh Verma, Bangalore (IN); Brent Teitel, New York, NY (US)

(21) Appl. No.: 18/350,662

(22) Filed: Jul. 11, 2023

(51) Int. Cl. G06Q 20/02; G06Q 20/40

(52) U.S. Cl. CPC G06Q 20/023; G06Q 20/4016; G06Q 20/409

(57) ABSTRACT

Systems, apparatuses, methods, and computer program products are disclosed for transaction facilitation via a plurality of clearinghouse devices. An example method includes receive, from a user device, a transaction request and determining, based on the transaction request and a clearinghouse mapping protocol, whether the first clearinghouse device is to facilitate a transaction associated with the transaction request. The method also includes in response to determining that the first clearinghouse device is to facilitate the transaction, authenticating the user device, facilitating the transaction associated with the transaction request, generating an audit trail object based on the facilitated transaction, and causing transmission of the audit trail object to a central entity.

### BACKGROUND

A centralized clearinghouse may ensure that funds are transferred securely between parties. However, conventional implementations involving a centralized clearinghouse exhibit numerous drawbacks and limitations.

### BRIEF SUMMARY

A clearinghouse may facilitate a settlement process between, e.g., merchants, banks, and payment networks. For example, in the context of a credit card purchase, a clearinghouse may act as an intermediary between a merchant's acquiring bank and a card issuer (e.g., a bank that issued a credit card to a consumer). In this regard, a clearinghouse may ensure that an appropriate amount is debited from the consumer's credit card account and credited to the merchant's account. This process typically involves debiting the card issuer's account held at the clearinghouse and crediting the acquiring bank's account.

In traditional implementations, a single, centralized clearinghouse may facilitate a vast amount of transactions. Due to its singular and central nature, a centralized clearinghouse may utilize batch processing, which involves collecting a set of transactions over a period of time (e.g., a day) and processing them together in a batch. The centralized clearinghouse may do so for efficiency purposes, e.g., to reduce overall infrastructure and operational costs. However, while batch processing has its advantages, it introduces latency between transaction initiation and settlement due to the periodic nature of batch processing. Since batch processing treats transactions as a group, individual transaction-level details may not be readily available until batch processing is complete, and this lack of granularity may make it challenging to perform real-time analytics, monitor individual transaction progress, or address specific transaction-related issues promptly.

Additionally, there are many drawbacks to using a single, centralized clearinghouse. For example, a centralized clearinghouse represents a single point of failure. If an issue (e.g., a technical issue, outage, security breach, or the like) with the centralized clearinghouse arises, the entire clearing and settlement process may be disrupted, causing significant delays and financial loss. A centralized clearinghouse also has limitations regarding scalability; as transaction volume increases, a centralized clearinghouse may struggle to handle the growing demand which may lead to bottlenecks and delays. Further, this singular and central nature may lead to a lack of transparency in its clearing and settlement processes. In this regard, participants (e.g., merchants, consumers, etc.) may not have real-time visibility into the status of their transactions or access to complete and timely data (e.g., due to batch processing). Centralized clearinghouses also have rigid structures and processes that may hinder the adoption of new technologies, which may impede efficiency gains and limit the introduction of new services and products.

In contrast to conventional techniques involving a centralized clearinghouse, example embodiments described herein provide for deployment of an interconnected network of localized clearinghouse devices which leverage advanced cellular communication capabilities to effectively settle transactions and eliminate the need for conventional centralized clearinghouse implementations that utilize batch processing.

Example embodiments leverage advancements in cellular communication technologies. These advancements have led to improvements in wireless networks and the way devices communicate with each other. For example, the evolution from Second Generation (2G) to Fifth Generation (5G) and soon Sixth Generation (6G) has brought a significant increase in available bandwidth, which has enabled devices to transfer a greater amount of data in real-time. Additionally, advanced generations of cellular networks have significantly reduced data transfer latency and improved device-to-device communication, allowing devices to communicate directly with each other without needing to go through a centralized network. In some embodiments, a clearinghouse device may be established within a high-density cellular network area. To mitigate the need for transaction data to be transmitted a long distance to a centralized clearinghouse (e.g., increasing risk for possible interception and/or exposure of sensitive financial information) and settled at a later stage (e.g., through batch processing), transactions can instead be settled in real-time within the network itself via the localized clearinghouse device.

In various embodiments, localized clearinghouse devices may be interconnected and communicate with each other, and overall network traffic may be reduced through settlements via the localized clearinghouse devices (e.g., within the dense network area itself via cloud rails positioned in the network). In this regard, even though localized clearinghouse devices may manage a heavy payload, once the entities of the transaction are validated, there is no need to communicate transaction data with the rest of the network.

In various embodiments, localized clearinghouse devices may act as a clearing gateway. In this regard, as further discussed herein, advanced cellular network capabilities may be leveraged by clearinghouse devices to identify nearby devices (e.g., user devices and/or merchant devices) and, using historical data, identify which devices commonly perform transactions along with the type of transactions performed. In this regard, future transactions may be predicted in order to ready an account balance and pre-authorize to ensure the clearinghouse device maintains efficiency (e.g., bottlenecks during high-volume transaction periods may be avoided by pre-authorizing transactions ahead of time such as during slower periods).

In various embodiments, fraud may be identified and prevented more efficiently through localized clearinghouse devices. If fraud (e.g., a fraudulent transaction request) is detected at a localized clearinghouse device, the localized clearinghouse device may be temporarily disabled (and other transaction requests re-routed to one or more other clearinghouse devices) until the situation is resolved. In some embodiments, localized clearinghouse device fraud detection may also include multiple models (e.g., at respective clearinghouse devices) that are continuously making predictions within a local network. In some embodiments, each node or clearinghouse device within the network area can leverage a fraud detection engine to analyze and monitor for potential fraud with respect to incoming transaction requests. In some embodiments, localized clearinghouse devices may take various actions to mitigate and/or contain suspected fraud, such as flag the device in question, temporarily disable the clearinghouse device or certain functionalities of the clearinghouse device, and/or block the particular entity from which the fraudulent transaction request originated.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a clearinghouse device that may perform various operations in accordance with some example embodiments described herein.

FIG. 3 illustrates a schematic block diagram of example circuitry embodying a user device and/or merchant device that may perform various operations in accordance with some example embodiments described herein.

FIG. 4 illustrates an example flowchart for facilitating transactions via a plurality of clearinghouse devices, in accordance with some example embodiments described herein.

FIG. 5 illustrates an example flowchart for pre-authorizing a transaction, in accordance with some example embodiments described herein.

FIG. 6 illustrates another example flowchart for mitigating fraud via a clearinghouse device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices. A “user device” may refer to a mobile device or more generally a computing device belonging to or otherwise associated with a user (e.g., a consumer). A “merchant device” may refer to a computing device belonging to or otherwise associated with a merchant (e.g., a retailer, corporation, organization, and/or the like that is in the business of a providing a good, service or experience to a consumer or otherwise operating in the stream of commerce). For example, a merchant device may comprise a point-of-sale (POS) device.

A “trace object” refers to a data structure that indicates various data regarding a facilitated transaction (e.g., an identification of parties involved, amount(s) transferred, type of goods purchased, timing information (e.g., a date and/or time of the transaction) and the like). Each clearinghouse device of the plurality of clearinghouse devices 102-1 through 102-N may generate trace objects based on transactions which they facilitate and cause transmission of the trace objects (e.g., individually as generated or in batches periodically) to a central entity 108, which may utilize the trace objects for accounting, reconciliation, dispute resolution, and/or bookkeeping purposes.

### System Architecture

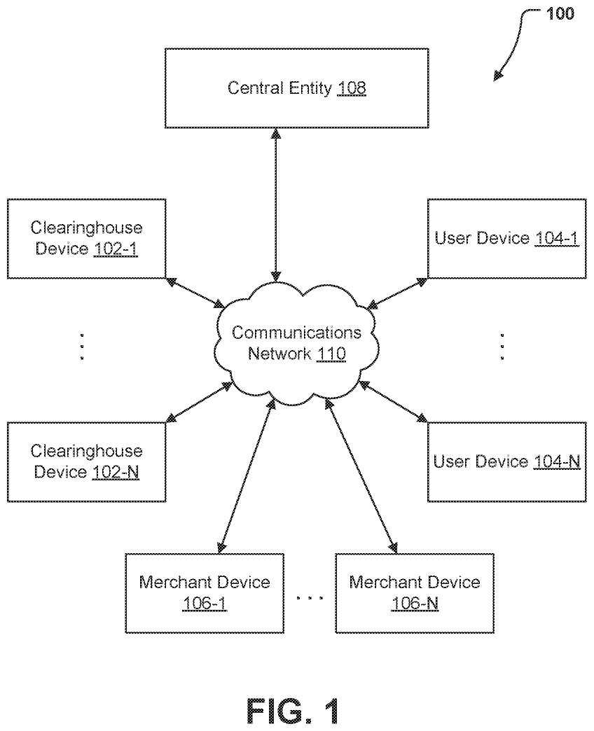

Example embodiments described herein may be implemented using any of a variety of computing devices or servers. To this end, FIG. 1 illustrates an example environment 100 within which various embodiments may operate. As illustrated, a plurality of clearinghouse devices (e.g., the first clearinghouse device 102-1, a second clearinghouse device 102-2 (not pictured), and the Nth clearinghouse device 102-N) may receive and/or transmit information via communications network 110 (e.g., the Internet) with any number of other devices, such as user devices (e.g., the first user device 104-1, a second user device 104-2 (not pictured), and the Nth user device 104-N), merchant devices (e.g., the first merchant device 106-1, a second merchant device 106-2 (not pictured), and the Nth merchant device 106-N), and/or a central entity 108.

In some embodiments, the communications network may comprise a cellular network, such as a sixth generation (6G) cellular network or similar advanced cellular network. In this regard, example embodiments may leverage advanced capabilities of a cellular network in order to carry out various operations described herein. For example, a 6G cellular network may offer faster and more reliable data transmission than previous generations of cellular networks, as well as new technologies such as terahertz frequencies, beamforming, and massive MIMO (Multiple Input, Multiple Output) which uses multiple antennas to send and receive signals, thereby improving signal strength and overall capacity of the network. To this end, communications network 110 may comprise a variety of devices not explicitly shown in FIG. 1, such as base stations, antennas, edge devices (e.g., routers), and/or the like which serve various functions in transmitting data throughout the communications network (e.g., transmitting data between clearinghouse devices, merchant devices, user devices, and/or a central entity).

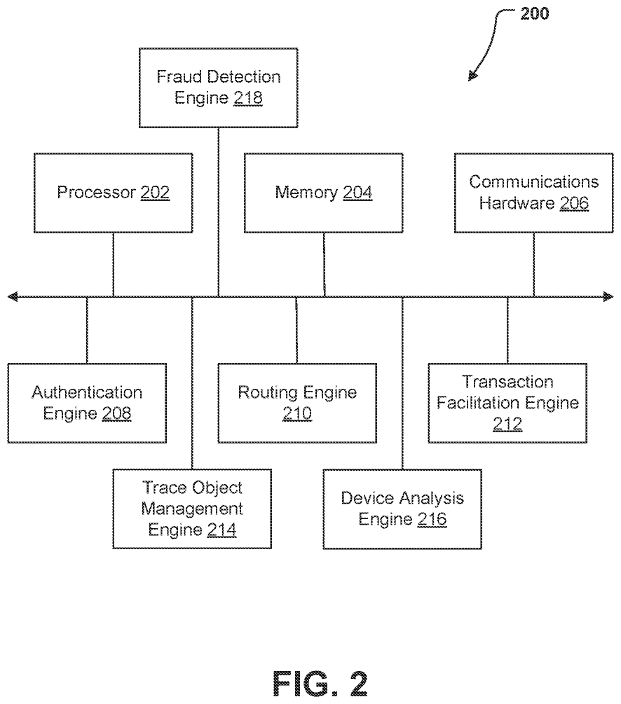

Each of the clearinghouse devices 102-1 through 102-N may be implemented as one or more computing devices or servers, which may be composed of a series of components. Particular components of a clearinghouse device (e.g., any one of clearinghouse devices 102-1 through 102-N) are described in greater detail below with reference to apparatus 200 in connection with FIG. 2.

In various embodiments, each clearinghouse device of the plurality of clearinghouse devices (e.g., clearinghouse devices 102-1 through 102-N) is configured to electronically settle transactions associated with a respective location in real-time. That is, each clearinghouse device is responsible for facilitating a transaction associated with a respective location. In some embodiments, for example, a particular clearinghouse device may be configured to facilitate transactions occurring within a location that makes up a predefined region (e.g., a predefined region as defined by particular location coordinates, such as a city, county, neighborhood, or the like).

In some embodiments, for example, a particular clearinghouse device may be configured to facilitate transactions that occur within a location associated with a particular business. For example, a clearinghouse device may be deployed within or near a department store and configured to facilitate all transactions related to that department store (e.g., occurring within the department store via one or more merchant devices or user devices, or occurring within a mobile application (e.g., installed on a user device) related to the department store (e.g., a purchase of a good from the department store).

In some embodiments, for example, a particular clearinghouse device may be configured to facilitate transactions that occur within a plurality of locations associated with plurality of businesses (i.e., merchants). In this regard, for example, a group of businesses may form a predefined partnership wherein the group of businesses each utilize a particular clearinghouse for transactions associated with the businesses of the predefined partnership. As one example, a group of small businesses within a particular city may form a predefined partnership to subscribe to a particular clearinghouse local to the city, and this clearinghouse may be configured to facilitate transactions stemming from or otherwise associated with the particular businesses of the syndicate. By doing so, merchants may gain the advantage of being able to perform more detailed and real-time analytics for their transactions and experience increased speed, reduced errors, and more fraud controls when compared with conventional, centralized clearinghouse batch processing techniques.

In some embodiments, a central entity 108 may comprise a central device, organization, institution, and/or other entity which, to some degree, manages or otherwise facilitates certain operations related to the plurality of clearinghouse devices. For instance, in some embodiments, a central entity 108 may comprise a central clearinghouse device. In some embodiments, a central entity may comprise a financial institution, such as a bank responsible for managing the plurality of clearinghouse devices. In various embodiments, a central entity 108 may act to perform various reconciliation and reporting processes regarding transactions which are facilitated by various clearinghouse devices. To do so, a central entity 108 may receive trace objects from clearinghouse devices for accounting, reconciliation, dispute resolution, and/or bookkeeping purposes. In this regard, a central entity 108 may utilize trace objects to generate and provide settlement reports to participating banks, payment networks, and/or the like, which include detailed information about transactions processed by various clearinghouse devices, settlement amounts, fees, and other relevant data. This allows participating parties to reconcile these reports with their own records to ensure accuracy and resolve any discrepancies.

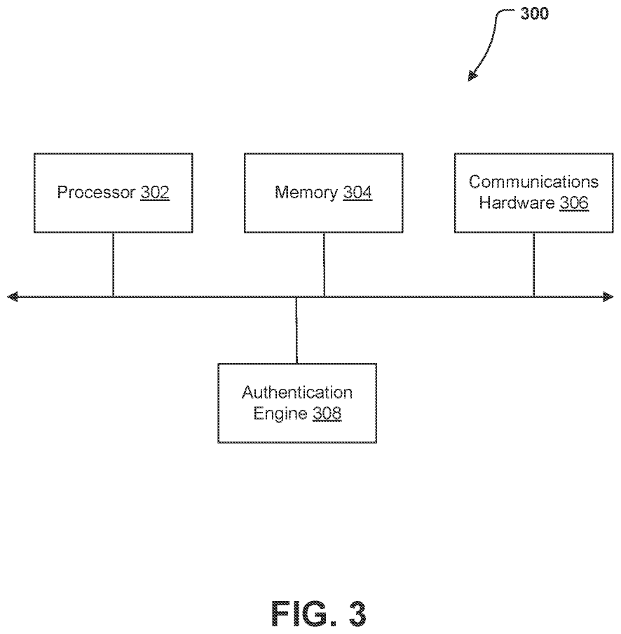

The one or more user devices 104-1 through 104-N and the one or more merchant devices 106-1 through 106-N may be embodied by any computing devices known in the art. The one or more user devices 104-1 through 104-N and the one or more merchant devices 106-1 through 106-N need not themselves be independent devices, but may be peripheral devices communicatively coupled to other computing devices. Particular components of a user device or a merchant device are described in greater detail below with reference to apparatus 300 in connection with FIG. 3.

### Example Implementing Apparatuses

A clearinghouse device (e.g., any of clearinghouse devices 102-1 through 102-N, described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, an authentication engine 208, a routing engine 210, a transaction facilitation engine 212, a trace object management engine 214, a device analysis engine 216, and a fraud detection engine 218, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

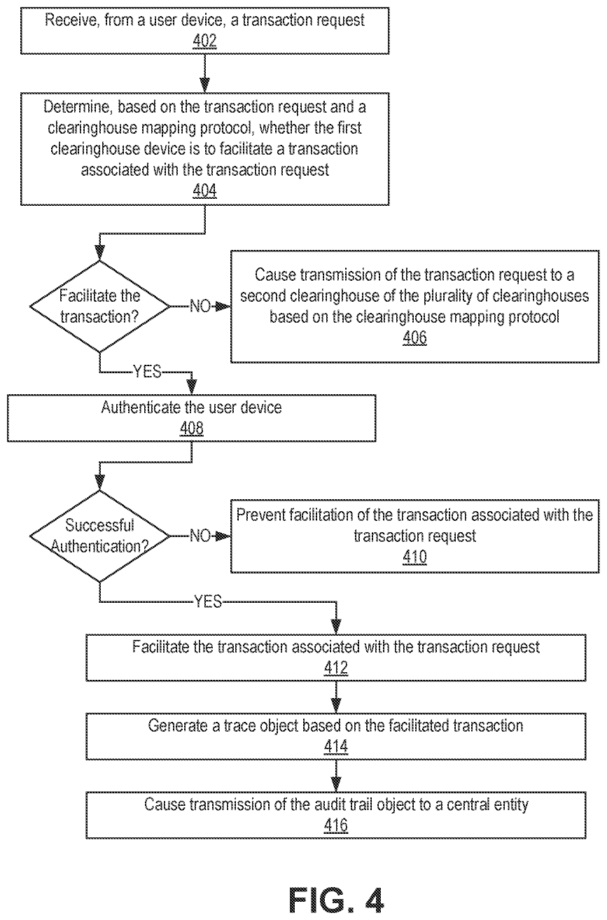

In addition, the apparatus 200 further comprises an authentication engine 208 that authenticates a device (e.g., a user device and/or merchant device). The authentication engine 208 may utilize processor 202, memory 204, or any other hardware component included in the apparatus 200 to perform these operations, as described in connection with FIG. 4 below. The authentication engine 208 208 may further utilize communications hardware 206 to gather data from a variety of sources (e.g., user devices 104-1 through 104-N, merchant devices 106-1 through 106-N, a central entity 108, and/or other clearinghouse devices 102-1 through 102-N, as shown in FIG. 1), and/or exchange data with a user, and in some embodiments may utilize processor 202 and/or memory 204 to authenticate a device. In some embodiments, authentication engine 208 may authenticate a device based at least on one or more of an authenticated session via a mobile application executing on the device, a device signature based on historical transaction requests associated with the device, and one or more authentication factors received from the device (e.g., in connection with a transaction request).

In addition, the apparatus 200 further comprises a routing engine 210 that determines whether or not to facilitate a transaction associated with a transaction request, and, if not, determines a clearinghouse device which is to facilitate the transaction. The routing engine 210 may determine whether or not to facilitate a transaction associated with a transaction request based on the transaction request and a clearinghouse mapping protocol, as further described herein. The routing engine 210 may utilize processor 202, memory 204, or any other hardware component included in the apparatus 200 to perform these operations, as described in connection with FIG. 4 below. The routing engine 210 may further utilize communications hardware 206 to gather data from a variety of sources (e.g., user devices 104-1 through 104-N, merchant devices 106-1 through 106-N, a central entity 108, and/or other clearinghouse devices 102-1 through 102-N, as shown in FIG. 1), and/or exchange data with a user, and in some embodiments may utilize processor 202 and/or memory 204 to determine, based on a transaction request and a clearinghouse mapping protocol, whether a clearinghouse device is to facilitate a transaction associated with the transaction request.

Further, the apparatus 200 further comprises a transaction facilitation engine 212 that facilitates a transaction associated with a received transaction request. The transaction facilitation engine 212 may utilize processor 202, memory 204, or any other hardware component included in the apparatus 200 to perform these operations, as described in connection with FIG. 4 below. The transaction facilitation engine 212 may further utilize communications hardware 206 to gather data from a variety of sources (e.g., user devices 104-1 through 104-N, merchant devices 106-1 through 106-N, a central entity 108, and/or other clearinghouse devices 102-1 through 102-N, as shown in FIG. 1), and/or exchange data with a user, and in some embodiments may utilize processor 202 and/or memory 204 to facilitate a transaction. In various embodiments, the transaction facilitation engine 212 may facilitate a transaction by performing settlement and funds transfer processes (as well as other processes which may be performed by a clearinghouse). For instance, a settlement process may involve determining net amount owed between parties associated with the transaction. A funds transfer process may involve facilitating a transfer of funds between an acquiring bank and a card issuer (e.g., in the example of a credit card purchase). In this regard, the transaction facilitation engine 212 may ensure an appropriate amount is debited from a consumer's account and credited to a merchant's account, for example. In some embodiments, the funds transfer process may involve debiting a card issuer's account held at the clearinghouse device and crediting an acquiring bank's account.

In addition, the apparatus 200 further comprises a trace object management engine 214 that generates a trace object based on a facilitated transaction. In some embodiments, the trace object management engine 214 may also generate a trace object batch comprising a plurality of trace objects each associated with a respective transaction facilitated by a particular clearinghouse device. The trace object management engine 214 may utilize processor 202, memory 204, or any other hardware component included in the apparatus 200 to perform these operations, as described in connection with FIG. 4 below. The trace object management engine 214 may further utilize communications hardware 206 to gather data from a variety of sources (e.g., user devices 104-1 through 104-N, merchant devices 106-1 through 106-N, a central entity 108, and/or other clearinghouse devices 102-1 through 102-N, as shown in FIG. 1), and/or exchange data with a user, and in some embodiments may utilize processor 202 and/or memory 204 to generate trace objects and/or trace object batches.

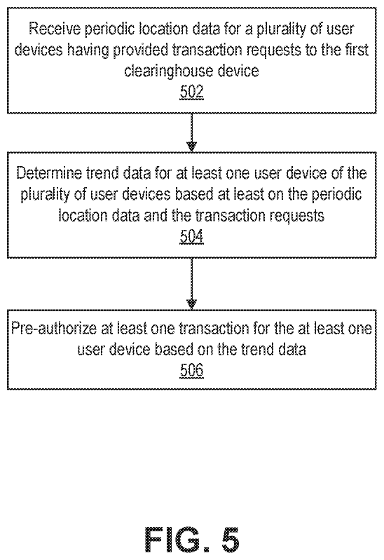

In addition, the apparatus 200 further comprises a device analysis engine 216 that determines trend data for devices having provided transaction requests to a clearinghouse device and pre-authorizes at least one transaction for at least one user device based on the trend data. The device analysis engine 216 may determine trend data based on transaction requests and periodic location data for a plurality of devices. The device analysis engine 216 may utilize processor 202, memory 204, or any other hardware component included in the apparatus 200 to perform these operations, as described in connection with FIG. 5 below. The device analysis engine 216 may further utilize communications hardware 206 to gather data from a variety of sources (e.g., user devices 104-1 through 104-N, merchant devices 106-1 through 106-N, a central entity 108, and/or other clearinghouse devices 102-1 through 102-N, as shown in FIG. 1), and/or exchange data with a user, and in some embodiments may utilize processor 202 and/or memory 204 to determine trend data and pre-authorize at least one transaction for at least one user device based on the trend data. In various embodiments, “trend data” may comprise statistical data regarding a plurality of devices (e.g., user devices and/or merchant devices) that transmit transaction requests to a particular clearinghouse device over time. Trend data may be determined based on periodic location data of devices (e.g., data regarding where devices are located at given times) as well as data gained from transaction requests submitted to a clearinghouse device. In this regard, certain devices that commonly perform transactions in a particular area and which the clearinghouse facilitates regularly may become “trusted” by or otherwise known to the clearinghouse device such that certain transactions for the device may be pre-authorized ahead of actually being performed (as further discussed herein).

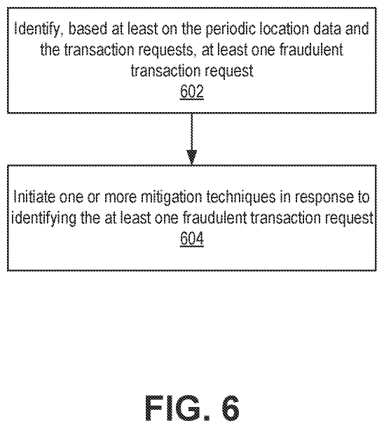

In addition, the apparatus 200 further comprises a fraud detection engine 218 that identifies fraudulent transaction requests and initiates one or more mitigation techniques in response to identifying fraudulent transaction requests. The fraud detection engine 218 may identify fraudulent transaction requests based at least on periodic location data and received transaction requests. The fraud detection engine 218 may utilize processor 202, memory 204, or any other hardware component included in the apparatus 200 to perform these operations, as described in connection with FIG. 6 below. The fraud detection engine 218 may further utilize communications hardware 206 to gather data from a variety of sources (e.g., user devices 104-1 through 104-N, merchant devices 106-1 through 106-N, a central entity 108, and/or other clearinghouse devices 102-1 through 102-N, as shown in FIG. 1), and/or exchange data with a user, and in some embodiments may utilize processor 202 and/or memory 204 to identify fraudulent transaction requests and initiate one or more mitigation techniques in response to identifying fraudulent transaction requests, as further discussed herein in connection with FIG. 6.

Although components 202-218 are described in part using functional language, it will be understood that the particular implementations necessarily include the use of particular hardware. It should also be understood that certain of these components 202-218 may include similar or common hardware. For example, the authentication engine 208, routing engine 210, transaction facilitation engine 212, trace object management engine 214, device analysis engine 216, and fraud detection engine 218 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the authentication engine 208, routing engine 210, transaction facilitation engine 212, trace object management engine 214, device analysis engine 216, and fraud detection engine 218 may leverage processor 202, memory 204, or communications hardware 206 as described above, it will be understood that any of authentication engine 208, routing engine 210, transaction facilitation engine 212, trace object management engine 214, device analysis engine 216, and fraud detection engine 218 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication engine 208, routing engine 210, transaction facilitation engine 212, trace object management engine 214, device analysis engine 216, and fraud detection engine 218 comprise particular machinery designed for performing the functions described herein in connection with such elements of apparatus 200.

As illustrated in FIG. 3, an apparatus 300 is shown that represents an example user device (e.g., any of user devices 104-1 through 104-N) or an example merchant device (e.g., any of merchant devices 106-1 through 106-N). The apparatus 300 includes processor 302, memory 304, and communications hardware 306, and may optionally include an authentication engine 308, each of which is configured to be similar to the similarly named components described above in connection with FIG. 2.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### Example Operations

Turning to FIGS. 4-6, example flowcharts are illustrated that contain example operations implemented by example embodiments described herein. The operations illustrated in FIGS. 4-6 may, for example, be performed by a given clearinghouse device (e.g., clearinghouse device 102-1, shown in FIG. 1), which may in turn be embodied by an apparatus 200, which is shown and described in connection with FIG. 2. To perform the operations described below, the apparatus 200 may utilize one or more of processor 202, memory 204, communications hardware 206, authentication engine 208, routing engine 210, transaction facilitation engine 212, trace object management engine 214, device analysis engine 216, and fraud detection engine 218, and/or any combination thereof. It will be understood that any user interaction with a clearinghouse device may occur directly via communications hardware 206, or may instead be facilitated by a separate device (e.g., a user device or merchant device) as shown in FIG. 1, and which may have similar or equivalent physical componentry facilitating such user interaction.

Turning first to FIG. 4, example operations are shown for facilitating transactions via a plurality of clearinghouse devices. As shown by operation 402, the apparatus 200 (e.g., a first clearinghouse device such as clearinghouse device 102-1) includes means, such as processor 202, memory 204, communications hardware 206, or the like, for receiving a transaction request.

In some embodiments, a transaction request may be received from a user device (e.g., any of user devices 104-1 through 104-N). In some embodiments, a transaction request may be received from a merchant device (e.g., any of merchant devices 106-1 through 106-N). In some embodiments, a transaction request may be received from both a user device and a merchant device (e.g., for a user device transacting with a merchant device within a store, each of the device may transmit a transaction request to a first clearinghouse device). The operations depicted in FIG. 4 will be explained below in the context of receiving a transaction request from a user device.

A transaction request may comprise data and/or metadata regarding a transaction which has been initiated by one or more devices. For instance, a transaction request may include payment information (e.g., payment card and/or account numbers and similar information, a payment amount of the transaction, and/or the like), timestamp data indicating a date and/or time the transaction was initiated, location data indicating a specific location where the transaction was initiated, device data such as one or more device identifiers (e.g., Media Access Control (MAC) addresses or similar identifiers) indicating one or more devices (e.g., a user device and/or a merchant device) involved in the transaction, and/or the like.

A transaction request may be received by a first clearinghouse device (e.g., apparatus 200) based on predefined criteria. As one example, transaction requests may be routed to a first clearinghouse device based on having been initiated within a certain location (e.g., within a predefined region). In this regard, transaction requests comprising specific location data, e.g., GPS coordinates, that falls within a range of location coordinates may be automatically routed to that first clearinghouse device. However, there may be other (nearby) clearinghouse devices which are configured to process specific transaction requests based on information other than location data. In this regard, the first clearinghouse device may first analyze the transaction request to determine whether the first clearinghouse device as actually responsible for facilitating a transaction associated with the transaction request, and, if not, determining a specific clearinghouse device which is responsible for facilitating the transaction associated with the transaction request. To do so, the first clearinghouse device may utilize a clearinghouse mapping protocol.

A clearinghouse mapping protocol may comprise a data structure which maps clearinghouse devices to certain aspects of transactions. The clearinghouse mapping protocol may be particular to clearinghouse devices within a predefined location (e.g., a predefined region) and distributed to all of the clearinghouse devices within that predefined location. The clearinghouse mapping protocol provides a way to associate specific characteristics or attributes of a transaction request with an appropriate recipient clearinghouse device. As one example, while a first clearinghouse device may receive a transaction request based on being the closest clearinghouse device to where the transaction was initiated, the transaction may actually be associated with a particular business which utilizes a specific clearinghouse device different from the first clearinghouse device, and therefore the transaction request should be routed to that specific clearinghouse device. As another example, while a first clearinghouse device may receive a transaction request based on being the closest clearinghouse device to where the transaction was initiated, the transaction request may indicate a payment amount less than a predefined amount, and a second clearinghouse device may be responsible for facilitating transactions amounting to less than a certain amount (e.g., less than $25.00) and therefore the transaction request should be routed to the second clearinghouse device. In various embodiments, the clearinghouse mapping protocol may utilize a plurality of rules which are executed in a hierarchy and, if a rule is triggered, the transaction request may be routed to a clearinghouse device associated with the rule. For instance, continuing with the examples above, a business characteristic may take priority over a payment amount characteristic. Said differently, a transaction request associated with a purchase from a particular business may be routed to the clearinghouse device associated with that business, regardless of whether the payment amount is less than $25.00.

In some embodiments, the clearinghouse mapping protocol may also comprise historical data related to previously facilitated transactions. For example, the clearinghouse mapping protocol may index a predefined number of previously facilitated transactions per originating device (e.g., any user devices or merchant devices from which transaction requests originate) in order to more readily identify when a new transaction (to be facilitated) should be flagged for pre-authorization. In this regard, if the new transaction exhibits consistency with the previously facilitated transactions indexed by the clearinghouse mapping protocol (e.g., includes characteristics such as timing, purchase amounts, purchase location, and/or the like similar or consistent with characteristics of the previously facilitated transactions indexed by the clearinghouse mapping protocol), the new transaction may be pre-authorized (e.g., to avoid certain processes or operations that would typically be performed for other devices with respect to a transaction request, as discussed further below in connection with FIG. 5).

In some embodiments, the clearinghouse mapping protocol may index a predefined number of recently facilitated transactions for originating devices. As one example, the clearinghouse mapping protocol may index the most recent three transactions for a specific device. In some embodiments, the indexed recent transactions may comprise transactions which were facilitated by multiple clearinghouse devices (e.g., a first transaction facilitated by clearinghouse device 102-1, a second transaction facilitated by clearinghouse device 102-2, and a third transaction facilitated by clearinghouse device 102-3).

In some embodiments, as conditions change, a clearinghouse mapping protocol may be dynamically updated in real-time (e.g., to reflect new responsibilities for certain clearinghouse devices) and transmitted to all clearinghouse devices within that predefined location. In some embodiments, a particular clearinghouse device may be configured to monitor conditions (e.g., online status, workload, etc.) of clearinghouse devices within a predefined region and dynamically update and distributed a revised clearinghouse mapping protocol should the situation arise. In other embodiments, the clearinghouse mapping protocol may be managed by another entity, such as central entity 108 or the like.

As shown by operation 404, the apparatus 200 includes means, such as processor 202, memory 204, routing engine 210, and/or the like, for determining, based on the transaction request and a clearinghouse mapping protocol, whether the first clearinghouse device is to facilitate a transaction associated with the transaction request. As noted above, the first clearinghouse device may extract attributes of the data contained in a transaction request and compare the data to the criteria defined by the clearinghouse mapping protocol, such that clearinghouse devices that match specified criteria based on the attributes of the transaction request may be identified. In some embodiments, this may involve executing a series of rules associated with the clearinghouse mapping protocol until a rule is triggered (e.g., returns a specific value). Once an appropriate clearinghouse device is identified, the first clearinghouse device may route the transaction request on to the identified clearinghouse device for further processing. In some embodiments, a clearinghouse device may be identified by a device identifier (e.g., MAC address or the like) unique to the clearinghouse device. In this regard, each clearinghouse of the plurality of clearinghouse devices may be identified by a unique identifier (e.g., an alphanumeric code or similar identifier).

As shown in FIG. 4, in response to determining that the first clearinghouse device is not to facilitate the transaction, the method may continue to operation 406, wherein the apparatus 200 includes means, such as processor 202, memory 204, communications hardware 206, or the like, for causing transmission of the transaction request to a second clearinghouse of the plurality of clearinghouses based on the clearinghouse mapping protocol. In this regard, the second clearinghouse device may receive the transaction request from the first clearinghouse device and proceed with performing steps 308-316 shown in FIG. 4 (and further discussed below).

In some embodiments, clearinghouse devices may transmit push or pull requests to other clearinghouse devices based on current workload. For example, an idle clearinghouse device which is currently not facilitating any transactions may transmit a pull request to one or more clearinghouse devices in order to indicate to those clearinghouse devices that the idle clearinghouse device is available to facilitate transactions (e.g., to case the computational processing burden of the one or more clearinghouse devices which may be facilitating a large number of transactions or have a large queue of transactions requests to facilitate).

Similarly, in some embodiments, a clearinghouse device overburdened with a number of transaction requests to facilitate may transmit a push request to one or more clearinghouse devices in order to offload one or more transaction requests to be facilitated to those one or more clearinghouse devices and free up computational resources. In some embodiments, push and pull requests may be transmitted by a first clearinghouse device to clearinghouse devices within a predefined proximity of the first clearinghouse device. In some embodiments, however, if all clearinghouse devices within that predefined proximity are overburdened (or idle), the first clearinghouse device may transmit push (or pull) requests to one or more clearinghouse devices located outside of that predefined proximity.

As shown in FIG. 4, in response to determining that the first clearinghouse device is to facilitate the transaction, the method may continue to operation 408, wherein the apparatus 200 includes means, such as processor 202, memory 204, authentication engine 208, or the like, for authenticating the user device.

In some embodiments, the first clearinghouse device may authenticate the user device based at least on an authenticated session via a mobile application executing on the user device. In some embodiments, the authenticated session may be active within a mobile banking application of the user device (e.g., through which the transaction associated with the transaction request was initiated). For instance, the first clearinghouse device may request proof of an active session from the mobile application of the user device. In this regard, the mobile application may provide a session token or unique identifier that confirms the existence of an authenticated session. The first clearinghouse device may then validate the session token or unique identifier received from the mobile application to ensure the session is valid and originated from the legitimate mobile application of the user device.

In some embodiments, the first clearinghouse device may authenticate the user device based at least on a device signature based on historical transaction requests associated with the user device. In this regard, the first clearinghouse device may retain a record of historical transaction requests submitted to the first clearinghouse device (and other clearinghouse devices) and may utilize data of those historical transaction requests (e.g., location data, timestamp data, payment amounts, payment types, account numbers, card numbers, etc.) to authenticate the user device. The first clearinghouse device may compare the transaction request (i.e., the present transaction request received at the first clearinghouse device) with the historical transaction requests to identify similarities, patterns, or other identifying characteristics and, based on this comparison, make a determination regarding the authenticity of the transaction request and, by extension, the user device. This determination may rely on factors such as matching request patterns, consistent headers, valid authentication tokens, and/or other relevant information contained in the historical transaction requests. In various embodiments, the first clearinghouse may maintain the record of historical transaction requests to ensure integrity of the record, for example, by encrypting the record of historical transaction requests. In various embodiments, authenticating the user device based at least on a device signature based on historical transaction requests associated with the user device may be complemented with other authentication measures, such as, e.g., authenticating the user device based on an authenticated session via a mobile application executing on the user device (as discussed above) and/or authenticating the user device based at least on one or more authentication factors received from the user device in connection with the transaction request (as discussed below).

In some embodiments, the first clearinghouse device may authenticate the user device based at least on one or more authentication factors received from the user device in connection with the transaction request. For instance, when initiating the transaction via the user device, a user may provide one or more authentication factors, such as a username/password combination, biometric factor(s), and/or the like (e.g., through multi-factor authentication (MFA)). As one example, a user may provide a fingerprint scan to their user device (e.g., a mobile phone) to authenticate themselves when making a purchase. This biometric marker may then be authenticated at the user device (e.g., by its own authentication engine 308) and an indication of a successful authentication of the user may be provided included in the transaction request.

As shown in FIG. 4, in response to an unsuccessful authentication of the user device, the method may continue to operation 410, wherein the apparatus 200 includes means, such as processor 202, memory 204, authentication engine 208, communications hardware 206, or the like, for preventing facilitation of the transaction associated with the transaction request. In various embodiments, an unsuccessful authentication of the user device may indicate a fraudulent transaction request, and, in response, the first clearinghouse device may initiate one or more mitigation techniques (as further discussed below in connection with FIG. 6). In preventing facilitation of the transaction, the first clearinghouse may notify the user device, one or more additional clearinghouse devices, and/or central entity 108 of the unsuccessful authentication of the user device and the prevention of the facilitation of the transaction.

As shown in FIG. 4, in response to a successful authentication of the user device, the method may continue to operation 412, wherein the apparatus 200 includes means, such as processor 202, memory 204, transaction facilitation engine 212, or the like, for facilitating the transaction associated with the transaction request. As discussed above, facilitating a transaction may involve numerous processes including a clearing process which ensures accurate transmission of transaction data between participating parties (e.g., a client device and a merchant device). The processes may also include a settlement process wherein the first clearinghouse device determines net amounts owed for the transaction, and a funds transfer process which involves debiting a card issuer's account and crediting an acquiring bank's account. In various embodiments, facilitating a transaction may be performed in real-time, for example, immediately in response to receiving a transaction request and authenticating the user device as discussed above, in contrast to conventional methods involving batch processing (wherein a centralized clearinghouse facilitates a batch of transactions at a later time).

In various embodiments, after facilitating a transaction, the first clearinghouse device may generate a trace object based on the facilitated transaction. In this regard, as shown by operation 414, the apparatus 200 includes means, such as processor 202, memory 204, trace object management engine 214, or the like, for generating a trace object based on the facilitated transaction. As discussed above, a trace object indicates various data regarding a facilitated transaction (e.g., an identification of parties involved, amount(s) transferred, type of goods purchased, timing information (e.g., a date and/or time of the transaction) and the like).

As shown by operation 416, the apparatus 200 includes means, such as processor 202, memory 204, communications hardware 206, or the like, for causing transmission of the trace object to a central entity. In various embodiments, each clearinghouse device of the plurality of clearinghouse devices 102-1 through 102-N may generate trace objects based on transactions which they facilitate and cause transmission of the trace objects (e.g., individually as generated or in batches periodically) to a central entity 108, which may utilize the trace objects for accounting, reconciliation, dispute resolution, and/or bookkeeping purposes.

In some embodiments, trace objects may be transmitted to a central entity in a batch processing manner. In this regard, the apparatus 200 includes means, such as processor 202, memory 204, trace object management engine 214, or the like, for generating a trace object batch comprising a plurality of trace objects. In some embodiments, trace object batches may be generated periodically (e.g., every hour, every 24 hours, etc.) and transmitted to the central entity for recordkeeping purposes. In this regard, the apparatus 200 includes means, such as processor 202, memory 204, communications hardware 206, or the like, for causing transmission of a trace object batch comprising the trace object and a plurality of additional trace objects each associated with a respective transaction facilitated by the first clearinghouse device. Advantageously, because the plurality of clearinghouse devices deployed in various locations are responsible for facilitating the transactions, the heavier processing (e.g., transaction request analysis and subsequent transaction facilitation) is kept localized at the clearinghouse devices and overall network traffic is reduced. In this regard, the only data that may be transmitted a great distance is lightweight trace object information, rather than actual transaction requests which would otherwise burden a centralized clearinghouse and have a greater impact on network bandwidth.

In some embodiments, as a clearinghouse device continuously facilitates transactions based on received transaction requests over time, the clearinghouse device may identify certain devices which consistently perform certain transactions or other actions and establish trust with those identified devices in order to conserve computational resources such as processing power and network bandwidth. In this regard, in some embodiments, a clearinghouse device may pre-authorize certain transactions for trusted devices to avoid certain processes or operations that would typically be performed for other devices with respect to a transaction request. Turning to FIG. 5, example operations are shown for pre-authorizing a transaction.

As shown by operation 502, the apparatus 200 (e.g., a first clearinghouse device) includes means, such as processor 202, memory 204, communications hardware 206, or the like, for receiving periodic location data for a plurality of user devices having provided transaction requests to the first clearinghouse device. In some embodiments, location data may be received by way of transaction requests (e.g., transaction requests that indicate location data of where a transaction was initiated). In some embodiments, location data may be received separately from transaction requests on a periodic basis directly (or indirectly) from user devices. For example, user devices may opt-in to providing location data to local clearinghouse devices (or to other device(s) that in turn provide the location data to clearinghouse devices) periodically. It is to be appreciated that while the operations depicted in FIG. 5 refer to a user device and will be explained below in the context of a user device, these operations apply to merchant devices as well in that location data may also be received for merchant devices, trend data for a merchant device may be determined, and transactions for merchant devices may be pre-authorized.

As shown by operation 504, the apparatus 200 includes means, such as processor 202, memory 204, device analysis engine 216, or the like, for determining trend data for at least one user device of the plurality of user devices based at least on the periodic location data and the transaction requests. In some embodiments, a device analysis engine 216 may extract relevant features from the transaction requests and location data associated with a particular device in order to identify trend data. With location data, this may involve extracting information such as frequency of visits to specific locations, distances traveled, patterns of movement, and/or the like. With transaction data, relevant features may include spending patterns, transaction frequencies, preferred merchants, preferred categories, and/or the like. In some embodiments, the device analysis engine 216 may then apply one or more machine learning algorithms and/or statistical analysis techniques to identify trends within the extracted features. For example, this may involve time series analysis and/or clustering to uncover correlations in the extracted features that reveal consistent trends over time.

As shown by operation 506, the apparatus 200 includes means, such as processor 202, memory 204, device analysis engine 216, or the like, for pre-authorizing at least one transaction for the at least one user device based on the trend data. In some embodiments, pre-authorizing a transaction may involve obtaining approval or authorization from another entity (e.g., a user's payment card issuer) for a transaction which is likely to take place at a later time. As an example, trend data determined by the device analysis engine 216 may indicate that a particular user regularly purchases gasoline at the same gas station every Sunday night between 7:00 PM and 8:00 PM using the same form of payment and in the same amount. The device analysis engine 216 may then determine to pre-authorize a transaction for gasoline for the user for the upcoming Sunday. In this regard, the device analysis engine 216 may obtain pre-authorization by causing transmission of a pre-authorization request to the user's card issuer (e.g., a bank) which includes an estimated amount of purchase and the anticipated date and time of the transaction. In some examples, by automatically pre-authorizing certain transactions ahead of time, a device clearinghouse can free up computational resources for other tasks which would have to be performed during the time at which the transaction takes place and therefore perform those tasks more efficiently.

In some embodiments, pre-authorizing a transaction may allow for the transaction to be facilitated without an authentication of the user device (e.g., at the time the actual transaction takes place). In this regard, trust may be established that

As discussed above, in some examples, a clearinghouse device may not be able to successfully authenticate a device that is attempting to perform a transaction, and this unsuccessful authentication may be an indicator of fraud. Additionally, a clearinghouse device may also utilize periodic location data and historical transaction requests to identify instances of fraud and, if detected, initiate various mitigation techniques to contain or prevent fraudulent transaction attempts. Turning to FIG. 6, example operations are shown for mitigating fraud via a clearinghouse device.

As shown by operation 602, the apparatus 200 includes means, such as processor 202, memory 204, fraud detection engine 218, or the like, for identifying, based at least on the periodic location data and the transaction requests, at least one fraudulent transaction request. In some embodiments, for a (user or merchant) device that provides transaction requests to a clearinghouse device, the fraud detection engine 218 may, over time, generate a behavior profile for the device. The behavior profile may indicate normal or expected user device behavior based on historical data, such as historical location data associated with the device and/or historical transaction requests associated with the device. The behavior profile may represent typical device use patterns, transaction characteristics, and location patterns associated with legitimate transaction requests. Upon receiving a transaction request, the fraud detection engine 218 may compare the transaction request to the behavior profile to identify any deviations or anomalies. In some instances, this may involve utilizing a fraud detection model (e.g., a machine learning (ML) or statistical model) to identify patterns or indicators that suggest fraudulent activity. In some examples, the fraud detection model may assign a risk score to the transaction request. In some embodiments, if the risk score satisfies a predefined risk threshold, the transaction request may be identified as a fraudulent transaction request. In this regard, each clearinghouse device of the plurality of clearinghouse devices may continuously monitor incoming transaction requests and assess the transaction requests for potentially fraudulent activity.

As shown by operation 604, the apparatus 200 includes means, such as processor 202, memory 204, fraud detection engine 218, or the like, for initiating one or more mitigation techniques in response to identifying the at least one fraudulent transaction request. In some embodiments, an example mitigation technique may involve temporarily disabling one or more functionalities of the clearinghouse device. For instance, the clearinghouse device may temporarily pause processing other transaction requests until the fraudulent transaction request is resolved. In this regard, the clearinghouse device may direct additional computational resources to the fraudulent transaction request while re-routing other transaction requests to another clearinghouse device (or multiple other clearinghouse devices). In this regard, the clearinghouse device may select one or more additional clearinghouse devices to route transaction requests to temporarily, based on, for example, location (e.g., the closest clearinghouse devices in proximity to the clearinghouse device), current workload, and/or the like. In some embodiments, an example mitigation technique may involve temporarily blocking the particular device from which the transaction request originated such that the device is prevented from having transaction requests processed by the plurality of clearinghouse devices within a particular region. In this regard, upon detection of a fraudulent transaction request, a clearinghouse device may broadcast a device identifier or similar information regarding the device from which the fraudulent transaction request originated to other clearinghouse devices in the network. These clearinghouse devices may then monitor for incoming transaction requests regarding the device identifier and prevent facilitation of any transactions related to those transaction requests.

FIGS. 4, 5, and 6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved transaction facilitation via a plurality of localized clearinghouse devices. Example embodiments thus provide tools that overcome the problems faced by conventional batch processing and transaction settlement techniques performed by a singular and centralized clearinghouse. As these examples all illustrate, example embodiments contemplated herein provide technical solutions that solve real-world problems impacting conventional transaction settlement processes performed by centralized clearinghouse. And while inefficient transaction settlement has been an issue for decades, the recently exploding amount of connected devices and payment options made available by recently emerging technology today has made this problem significantly more acute, as the demand for the ability for real-time transaction analytics and faster settlement has grown significantly. At the same time, the recently arising capabilities of advanced cellular communication technologies have unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a plurality of clearinghouse devices, wherein each clearinghouse device of the plurality of clearinghouse devices is configured to electronically settle transactions associated with a respective location in real-time,
wherein a first clearinghouse device of the plurality of clearinghouse devices is configured to:
receive, from a user device, a transaction request;
determine, based on the transaction request and a clearinghouse mapping protocol, whether the first clearinghouse device is to facilitate a transaction associated with the transaction request; and
in response to determining that the first clearinghouse device is to facilitate the transaction:
authenticate the user device; and
in response to a successful authentication of the user device:
facilitate the transaction associated with the transaction request;
generate a trace object based on the facilitated transaction; and
cause transmission of the trace object to a central entity.

2. The system of claim 1, wherein the first clearinghouse device is further configured to:
in response to determining that the first clearinghouse device is not to facilitate the transaction:
causing transmission of the transaction request to a second clearinghouse device of the plurality of clearinghouses devices based on the clearinghouse mapping protocol.

3. The system of claim 1, wherein the transaction request is associated with a first location, and wherein the first clearinghouse device is configured to process transaction requests originating from user devices located within the first location.

4. The system of claim 3, wherein the first location comprises a predefined region based on location coordinates.

5. The system of claim 3, wherein the first location comprises location associated with a particular business.

6. The system of claim 3, wherein the first location comprises one or more locations associated with a predefined partnership of businesses.

7. The system of claim 1, wherein causing transmission of the trace object comprises causing transmission of a trace object batch comprising the trace object and a plurality of additional trace objects each associated with a respective transaction facilitated by the first clearinghouse device.

8. The system of claim 1, wherein the trace object indicates transaction data associated with the facilitated transaction.

9. The system of claim 1, wherein the central entity comprises a central clearinghouse device in communication with the plurality of clearinghouse devices.

10. The system of claim 1, wherein the first clearinghouse device is further configured to:
receive periodic location data for a plurality of user devices having provided transaction requests to the first clearinghouse device;
determine trend data for at least one user device of the plurality of user devices based at least on the periodic location data and the transaction requests; and
pre-authorize at least one transaction for the at least one user device based on the trend data.

11. The system of claim 10, wherein pre-authorizing the at least one transaction allows for the at least one transaction to be facilitated without an authentication of the at least one user device.

12. The system of claim 10, wherein the first clearinghouse device is further configured to:
identify, based at least on the periodic location data and the transaction requests, at least one fraudulent transaction request; and
initiate one or more mitigation techniques in response to identifying the at least one fraudulent transaction request.

13. The system of claim 12, wherein the one or more mitigation techniques comprise re-routing one or more transaction requests to a second clearinghouse device of the plurality of clearinghouse devices.

14. The system of claim 12, wherein the one or more mitigation techniques comprise temporarily disabling one or more functionalities of the first clearinghouse device.

15. The system of claim 1, wherein the first clearinghouse device authenticates the user device based at least on one or more of (i) an authenticated session via a mobile application executing on the user device, (ii) a device signature based on historical transaction requests associated with the user device, and (iii) one or more authentication factors received from the user device in connection with the transaction request.

16. An apparatus comprising:
communications hardware of a first clearinghouse device configured to receive a transaction request from a user device, wherein the first clearinghouse device is associated with a plurality of clearinghouse devices, wherein each clearinghouse device of the plurality of clearinghouse devices is configured to electronically settle transactions associated with a respective location in real-time;
a routing engine of the first clearinghouse device configured to determine, based on the transaction request and a clearinghouse mapping protocol, whether the first clearinghouse device is to facilitate a transaction associated with the transaction request;
an authentication engine of the first clearinghouse device configured to, in response to determining that the first clearinghouse device is to facilitate the transaction, authenticate the user device;
a transaction facilitation engine of the first clearinghouse device configured to, in response to a successful authentication of the user device, facilitate the transaction associated with the transaction request; and
a trace object management engine of the first clearinghouse device configured to generate a trace object based on the facilitated transaction,
wherein the communications hardware of the first clearinghouse device is further configured to cause transmission of the trace object to a central entity.

17. The apparatus of claim 16, wherein the communications hardware of the first clearinghouse device is further configured to, in response to determining that the first clearinghouse device is not to facilitate the transaction:
cause transmission of the transaction request to a second clearinghouse device of the plurality of clearinghouses devices based on the clearinghouse mapping protocol.

18. The apparatus of claim 16, wherein the transaction request is associated with a first location, and wherein the first clearinghouse device is configured to process transaction requests originating from user devices located within the first location.

19. The apparatus of claim 16, wherein the communications hardware of the first clearinghouse device is further configured to receive periodic location data for a plurality of user devices having provided transaction requests to the first clearinghouse device, and wherein the apparatus further comprises a device analysis engine configured to:
determine trend data for at least one user device of the plurality of user devices based at least on the periodic location data and the transaction requests, and
pre-authorize at least one transaction for the at least one user device based on the trend data.

20. A method comprising:
receiving, by communications hardware of a first clearinghouse device, a transaction request from a user device, wherein the first clearinghouse device is associated with a plurality of clearinghouse devices, wherein each clearinghouse device of the plurality of clearinghouse devices is configured to electronically settle transactions associated with a respective location in real-time;
determining, by a routing engine of the first clearinghouse device and based on the transaction request and a clearinghouse mapping protocol, whether the first clearinghouse device is to facilitate a transaction associated with the transaction request;
authenticating, by an authentication engine of the first clearinghouse device and in response to determining that the first clearinghouse device is to facilitate the transaction, the user device;
facilitating, by a transaction facilitation engine of the first clearinghouse device and in response to a successful authentication of the user device, the transaction associated with the transaction request;
generating, by a trace object management engine of the first clearinghouse device, a trace object based on the facilitated transaction; and
causing, by the communications hardware of the first clearinghouse device, transmission of the trace object to a central entity.
